(19) United States
(12) Patent Application Publication
(10) Pub. No.: US 2003/0213645 A1
(43) Pub. Date: Nov. 20, 2003

(54) Fire rescue harness

(76) Inventor: Jeffrey A. Pine, Greenwood, IN (US)

Correspondence Address: Woodard, Emhardt, Moriarty, McNett & Henry LLP, Bank One Center/Tower, Suite 3700, 111 Monument Circle, Indianapolis, IN, 46204-5137, US

(21) Appl. No.: 10/410,053

(22) Filed: Apr. 9, 2003

Related U.S. Application Data
(60) Provisional application No. 60/371,996, filed on Apr. 10, 2002.

(51) Int. Cl. A62B 35/00

(52) U.S. Cl. 182/3

(57) ABSTRACT

A rescue harness for fire rescue personnel, preferably includes:

(a) a flexible head/neck support member for supporting a victim's head and neck when the harness is being used to pull the victim to safety, the flexible support member optionally extending over the victim's back to cover air tanks or other gear;

(b) a chest strap with attachment means (for example, a buckle) at each end of the strap, suitable for holding the victim in the harness by “buckling” the strap around the person's chest; and

(c) a grip attached to upper edge of the head support, the grip being suitable for use by gloved firefighters for pulling a person strapped in the harness from a building.

In one preferred embodiment, the rescue harness also includes a second strap for further retaining the victim, the second strap preferably having one end fixedly attached to the first strap, and having a second and releasably attached to the first strap with a buckle.

### FIELD OF THE INVENTION

The present invention relates generally to fire rescue harnesses, and more particularly to a compact, lightweight harness that is easily carried and quickly employed to assist in pulling a victim from a burning building.

### BACKGROUND OF THE INVENTION

Fire rescue personnel are occasionally required to remove unconscious or injured persons from buildings. Traditionally, the victim would be hoisted onto the rescuer's shoulders and removed from the building with the traditional “fireman's carry.” When the firefighter is wearing modern gear such as air tanks and other equipment on their shoulders though, it is more difficult to transport unconscious victims with the traditional carry.

In some cases the person to be evacuated from the building is an injured or unconscious firefighter. Since the downed firefighter is also wearing heavy, bulky gear, the obstacles to using the traditional fireman's carry are multiplied.

In view of the above it can be seen that there is a need for a rescue harness adapted specifically for fire rescue personnel use. The ideal harness would be simple and lightweight, convenient for a fire rescue person to fold up and carry easily, yet strong enough to secure and assist in removing a victim from a building. The present invention addresses that need.

### SUMMARY OF THE INVENTION

Briefly describing one aspect of the present invention, there is provided a rescue harness for fire rescue personnel to use for pulling people out of buildings. The harness is open to the front to allow easy access to the victim, and preferably includes:

(a) a flexible head/neck support for supporting a victim's head and neck when the harness is being used to pull the victim to safety, the flexible support member optionally extending over the victim's back to cover air tanks or other gear;

(b) a chest strap with attachment means (for example, a buckle) at each end of the strap, suitable for holding the victim in the harness by “buckling” the strap around the person's chest; and

(c) a grip attached to the upper edge of the head support, said grip being suitable for use by gloved firefighters in pulling a person strapped in the harness from a building.

The rescue harness may also optionally include a groin strap for further retaining the victim. One end of the groin strap is preferably fixedly attached to the lower portion of the flexible support, while the other end of the groin strap is releasably attached to the harness with a loop or buckle. Also, the rescue harness may optionally include a waist strap for further securing the victim by “buckling” the strap around the person's waist. Ties and pockets for securing the various parts of the harness in a compact package may also be included.

One object of the present invention to provide a simple, yet efficient rescue harness to enable fire rescue personnel to pull victims out of a building. Further objects and advantages of the present invention will become apparent through the following description.

### BRIEF DESCRIPTION OF THE DRAWINGS

FIG. 1 shows the rescue harness of the present invention, according to one preferred embodiment.

FIG. 2 shows the rescue harness of the present invention, according to a second preferred embodiment.

FIG. 3 is a perspective view of the rescue harness of the present invention, according to a third preferred embodiment.

FIG. 4 is a top plan view of the rescue harness of FIG. 3, with the groin strap enclosed in its pocket.

FIG. 5 is a top plan view of the rescue harness of FIG. 3, with the groin strap deployed.

FIG. 6 is a bottom plan view of the rescue harness of FIG. 5.

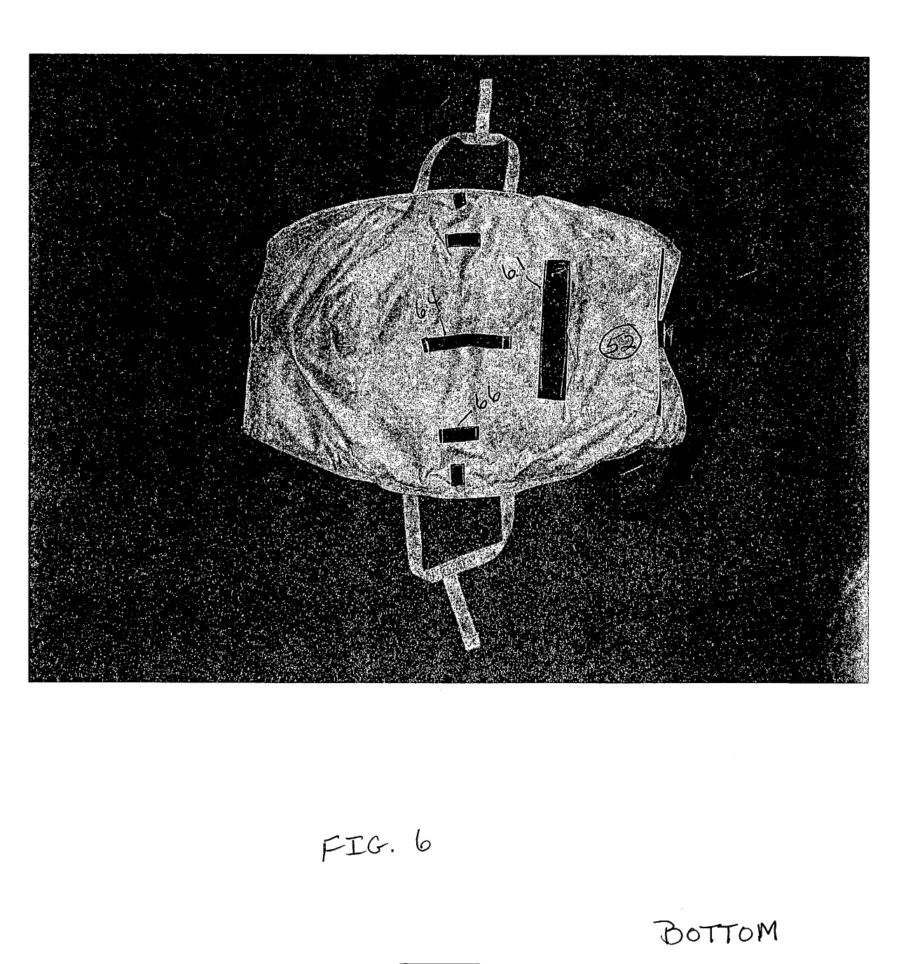

FIG. 7 shows the rescue harness of FIG. 6 with the back pocket open.

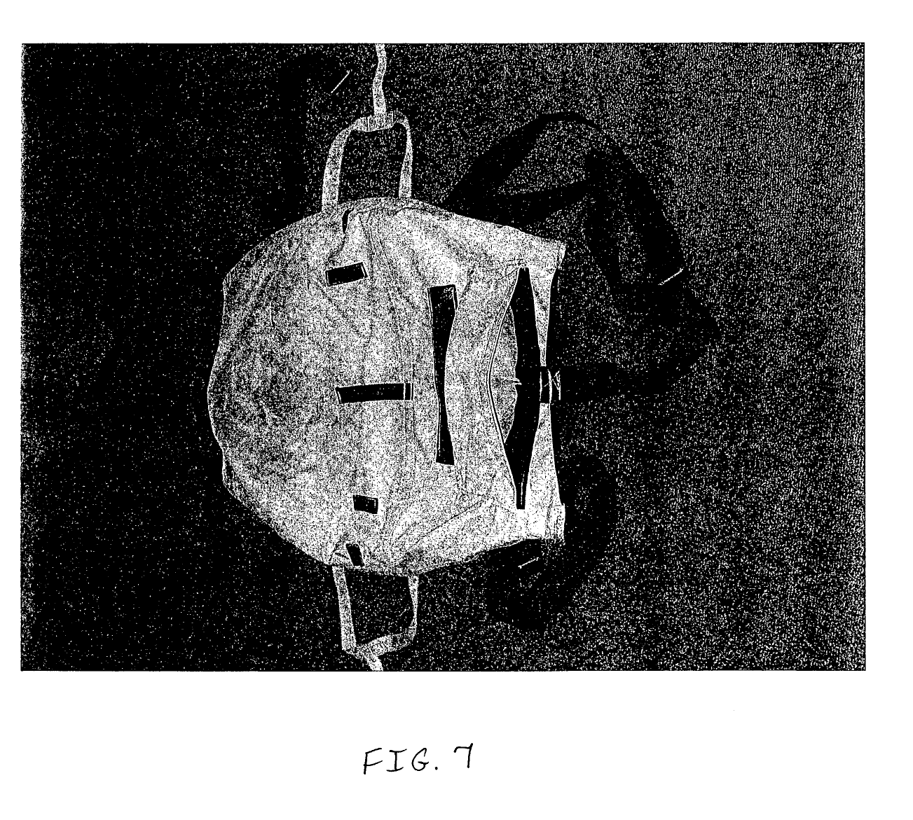

FIG. 8 shows the rescue harness of FIG. 2 secured to a victim.

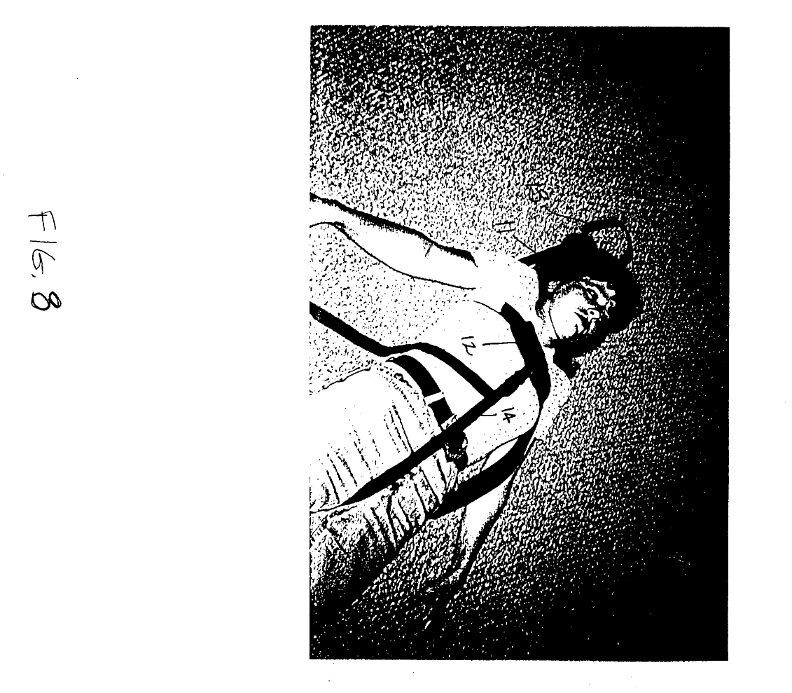

FIG. 9 shows the rescue harness of FIG. 2 in use.

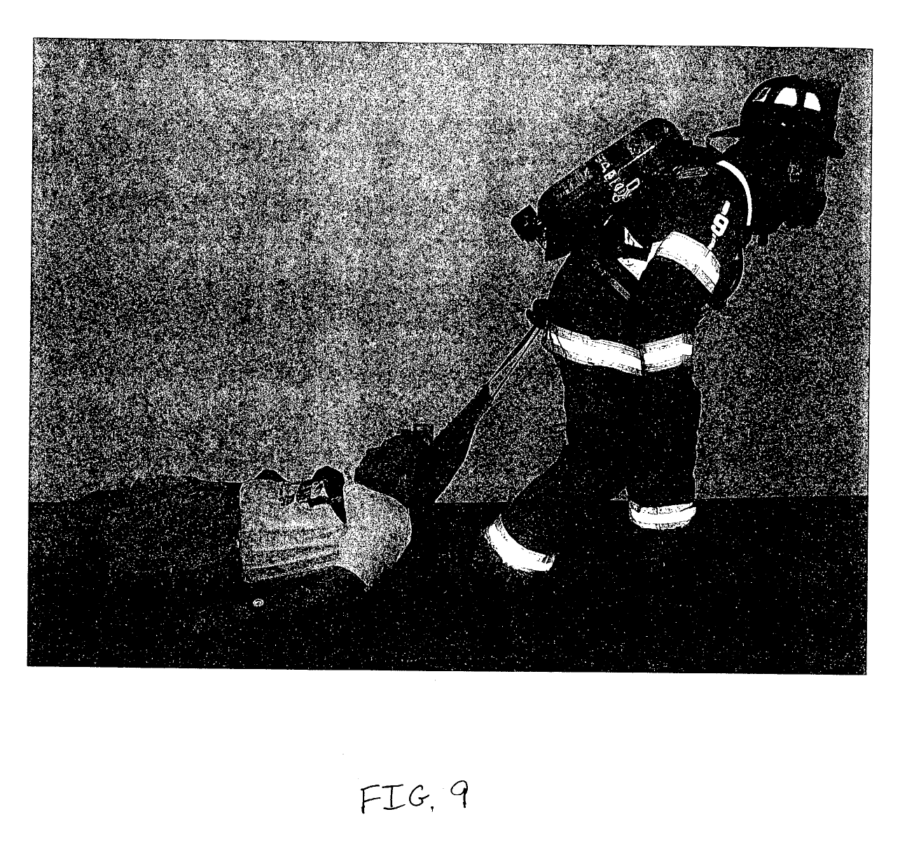

FIG. 10 shows the rescue harness of FIG. 5 being secured to a victim.

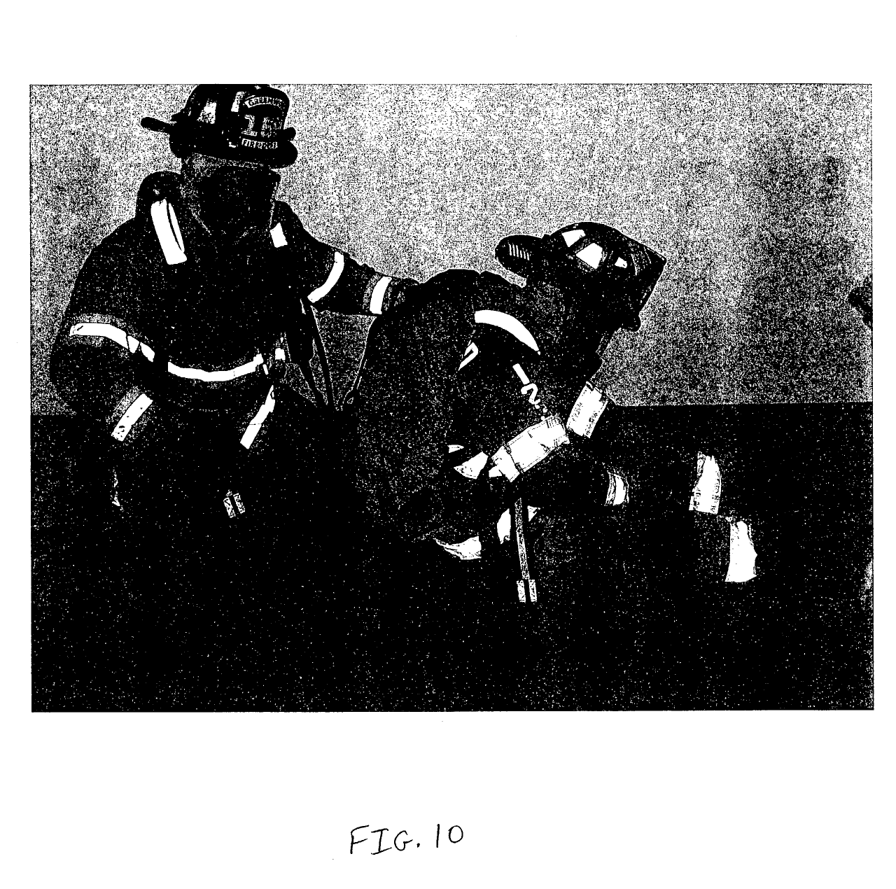

FIG. 11 shows the rescue harness of FIG. 5 being used to drag a victim.

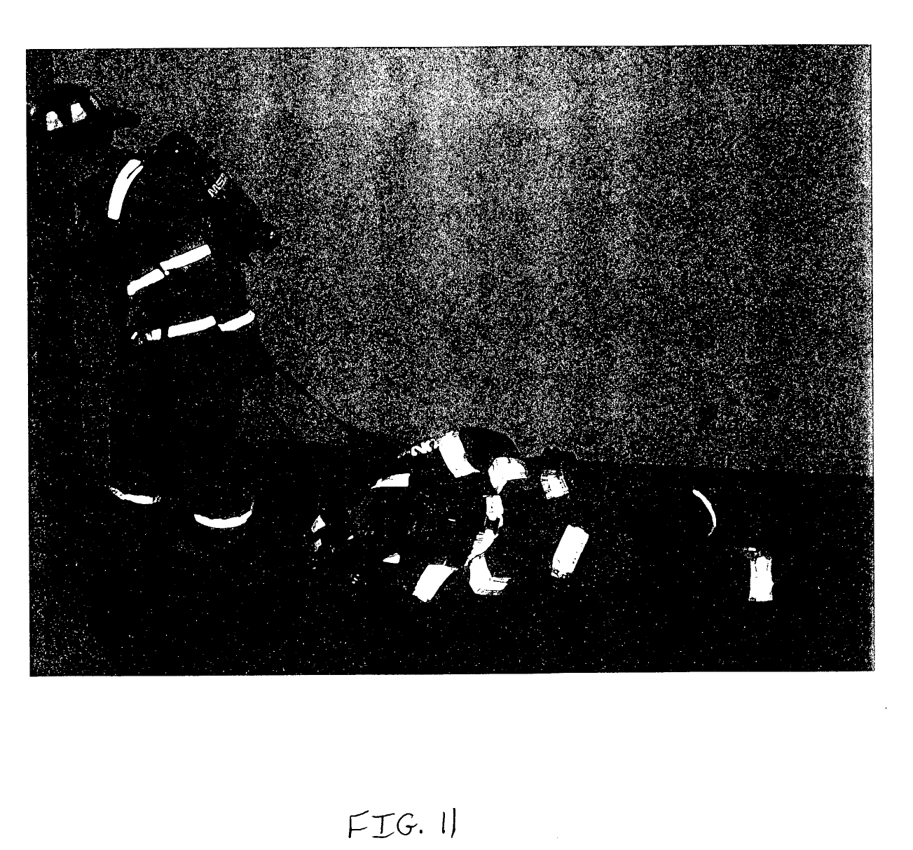

FIG. 12 shows the rescue harness of FIG. 5 being used to lift a victim.

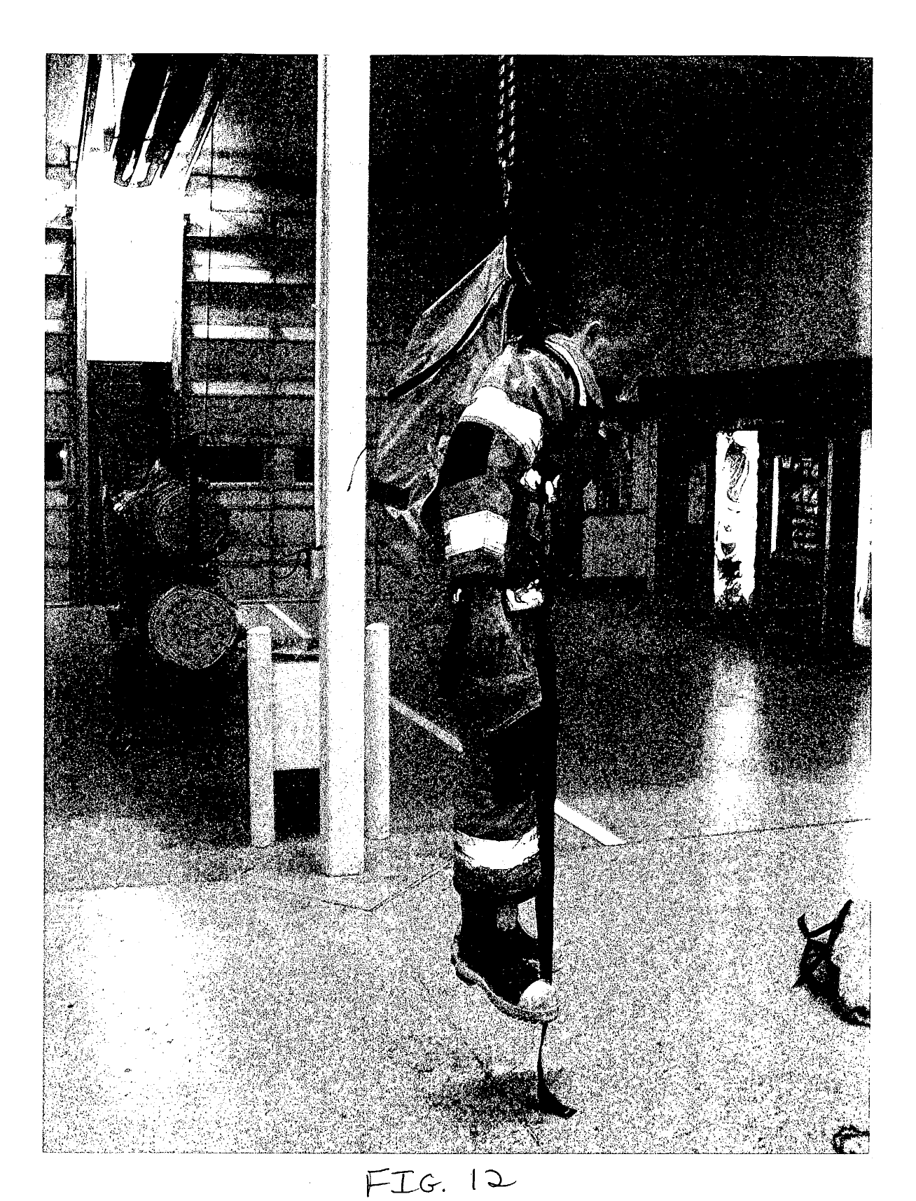

### DESCRIPTION OF THE PREFERRED EMBODIMENT

For the purposes of promoting an understanding of the principles of the invention, reference will now be made to the preferred embodiments, and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

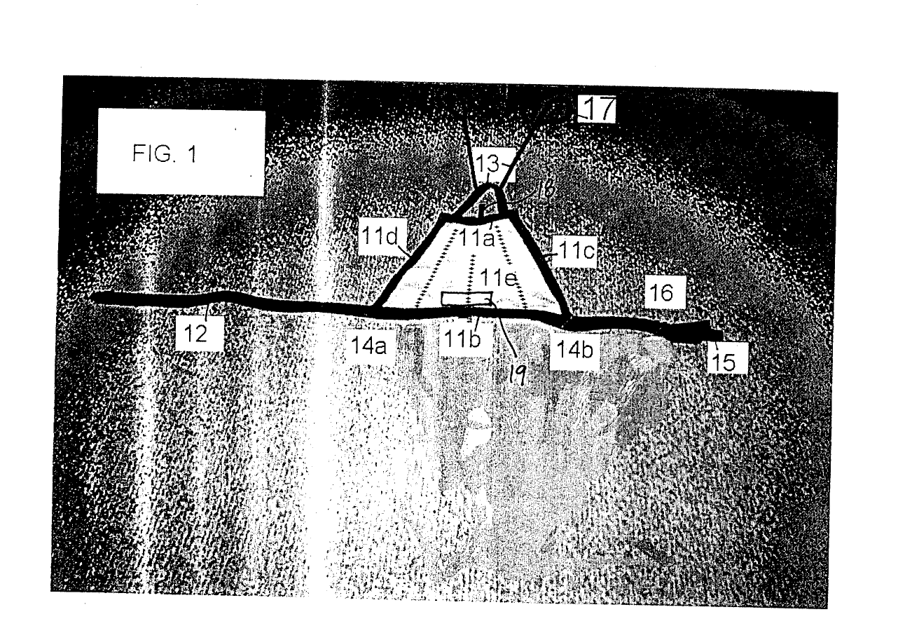

As shown in FIG. 1, one preferred embodiment of the present invention (hereinafter the “short back” embodiment) is a rescue harness for firefighters to use to pull people out of buildings. The illustrated short back harness comprises:

(a) a flexible head/neck support member 11 for supporting a victim's head and neck when the harness is being used to pull the victim to safety;

(b) a chest strap 12 with attachment means 15 (for example, a buckle) at each end of the strap, suitable for holding the victim in the harness by “buckling” the strap around the person's chest; and

(c) a grip 13 attached to upper edge 11a of support member 11, the grip being suitable for use by gloved firefighters for pulling a person strapped in the harness from a building.

Flexible head/neck support member 11 is sized to support a victim's head and neck when the harness is being used to pull the victim to safety. Accordingly, head/neck support 11 may be trapezoidal shaped with a bottom length of about 12 to 24 inches, a top length of about 6 to 18 inches, and sides that are about 10 to 20 inches long, as shown in FIG. 1. Alternatively, head/neck support 11 may be another suitable shape such as rectangular, semi-circular, etc. Dimensions are adjusted for alternative shapes so that support 11 is sized to support a person's head and neck, generally as illustrated in the drawings. In the most preferred embodiments head/neck support 11 has a length of between 12 and 24 inches, a width of between 12 and 24 inches, and an area of between about 150 and 600 square inches.

Flexible head/neck support member 11 is preferably made of a strong material such as nylon or heavyweight canvas that has been treated with a flame retardant. Since support 11 is used to support, cradle and protect the victim's head while the rescue is underway, support 11 should provide at least a modicum of protection. It is also desirable however, for the rescue harness to be small and compact, so a flexible, foldable head support made of canvas or a heavyweight plastic is generally preferred. In one preferred embodiment support 11 is inflatable so that it more effectively cushions and protects the victim's head.

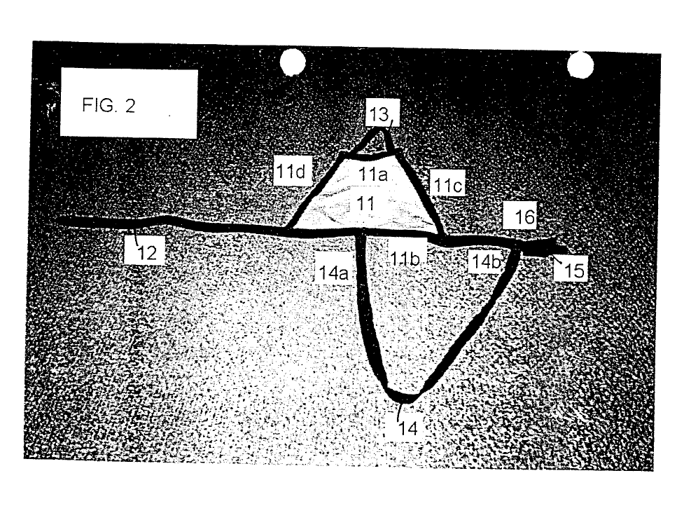

The rescue harness of FIG. 1 also includes a chest strap 12 for holding the victim in the harness. Chest strap 12 may be positioned at the bottom of flexible head/neck support member 11 as shown in the FIGS. 1 and 2. Attachment means (for example, a buckle 15) for buckling the strap around a victim's chest is also preferably provided at each end of the strap. In one preferred embodiment chest strap 12 includes Velcro fasteners to facilitate securing the strap around a victim's chest. In another preferred embodiment, chest strap 12 is secured around a victim's chest merely by tying the ends of the strap together.

Chest strap 12 is used to retain a person in the harness by “buckling” the strap around the person's chest, preferably under the person's arms. Thus, the strap must be long enough to accommodate large victims in bulky clothing, and must be strong enough to support even a large victim's weight. As previously noted however, the harness must be lightweight and compact. Accordingly, nylon or other suitable material is preferably used to make the chest strap. The strap is preferably between about 48 and 64 inches long, and is adjustable in length by securing and cinching the strap around the victim's chest.

A grip or handle 13 is attached to upper edge 11a of head/neck support 11. The grip or handle (the terms are used interchangeably to describe anything that fire rescue personnel can use to grasp the harness) must be suitable for assisting fire rescue personnel in pulling a person strapped in the harness from a building. Thus, the grip must be large enough to use by firefighters wearing gloves, such as a flexible canvas strap about twelve to twenty-eight inches long. A foam-rubber cushion member may be provided around the strap to cushion the grip.

In one preferred embodiment grip 13 is supplemented by an additional handle strap 17 that may be looped over the rescue person's shoulder. Supplemental handle strap 17 enables the rescue person to pull heavy victims from buildings, and to pull the rescue harness and victim without using one's hands.

In the embodiment shown in FIG. 2, the rescue harness also includes a second strap 14 (called a “groin strap” in this description) for further retaining the victim. Groin strap 14 preferably includes first and second ends 14a and 14b connected to chest strap 12, wherein at least one of said ends is releasably connected to the chest strap. Most preferably, strap 14 has one end 14a fixedly attached to chest strap 12, and one end 14b releasably attached to strap 12 with a buckle 16.

Groin strap 14 is preferably used to secure a rescue victim in the harness by holding the victim's torso and hips in the harness. This is accomplished by passing second strap 14 from chest strap 12, down under the victim's crotch and over the groin, and back up to chest strap 12, where the releasable strap end 14b is secured.

The rescue harness is prepared for use by securing chest strap 12 around the victim's chest. Groin strap 14 is also preferably secured. The rescue person uses grip 13 to pull the victim from the hazard area. Groin strap 14 is preferably contained in pouch 19 when the harness is not in use.

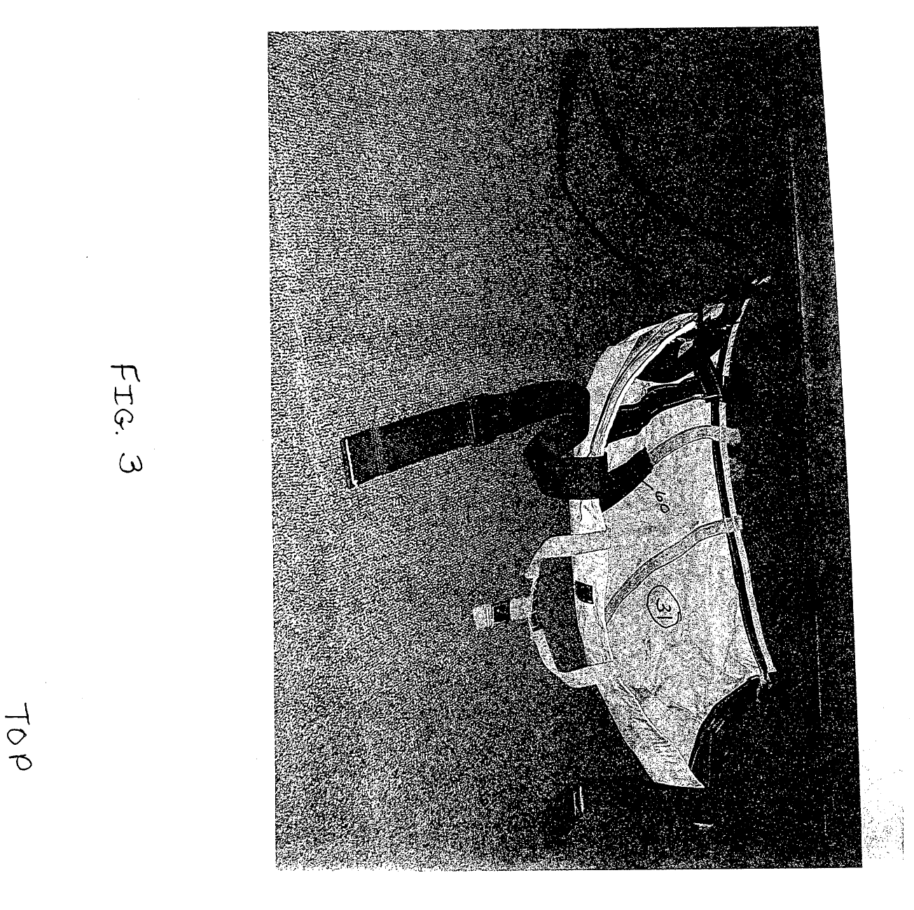

In another preferred embodiment (hereinafter the “long back” embodiment), shown in FIG. 3, flexible support member 31 is sized to extend far enough down the victim's back to at least partially cover air tanks or other equipment typically worn by firefighters. This embodiment provides all the advantages of the embodiments of FIGS. 1 and 2, and also prevents equipment on a fallen firefighter's back from becoming snagged while the firefighter is being evacuated in the harness. The long back embodiment accomplishes this by using webbing and fabric sewn together to create a harness that encapsulates the air pack and back of the firefighter.

As shown in the drawings, the flexible support member 31 of the long back embodiment is preferably about 12-24 inches wide, and about 18-36 inches long. Here too, the exact shape of the flexible member is not critical as long as it effectively supports the victim's head and neck, and covers enough of the victim's back to reduce the potential for snagging when dragging the victim to safety.

As shown in the drawings, the long back embodiment also includes a chest strap 32 as was described in the short back embodiment. Buckles, etc., are included on chest strap 32 as previously described.

Long back embodiment 30 also includes a grip or handle 33 as described in the short back embodiment above. A supplemental lifting loop 37 may also be included.

In the embodiment shown in FIG. 3, long back harness 30 includes a waist strap 35 to secure the harness around the victim's waist.

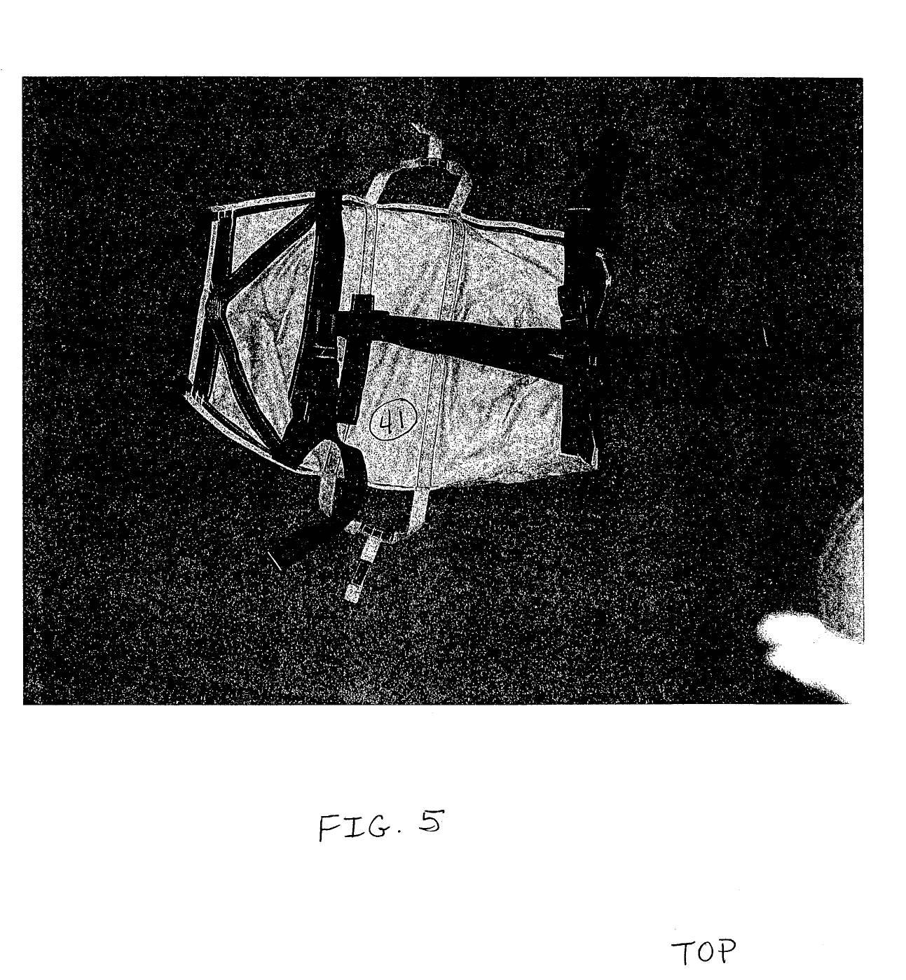

In the embodiment of FIG. 5, long back embodiment 40 also includes a groin strap 44 for further retaining the victim. One end of groin strap 44 is preferably fixedly attached to flexible support member 41, and the other end is preferably releasably attached.

Any of the long back embodiments may also include side handles 46 below the chest strap. Side handles 46 are preferably made using one continuous strap in a long oval shape sewn into the fabric of the harness with the ends of the oval protruding out from the sides far enough for easy use with gloved hands. Accordingly, the bottom side handle strap will be approximately 6 to 9 inches below the top side handle strap. These handles are preferably secured inside the harness until they are needed for use, and may be deployed by grabbing a tab 47 that protrudes from the side of the harness. Velcro fasteners 66 (and mating Velcro fasteners located on the side handles) may be used to secure the side handles in the harness package when they are not being used.

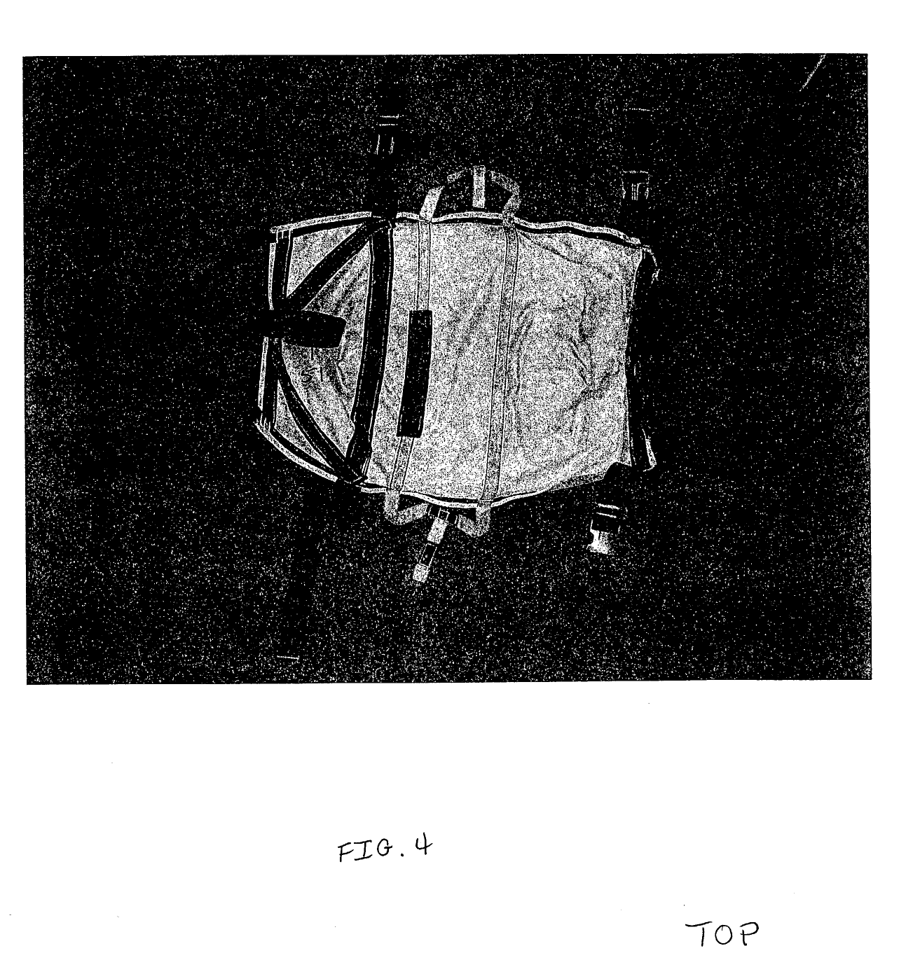

In the most preferred embodiments the rescue harness includes a strap (18 in FIG. 1, and 51 in FIG. 4) for securing the harness in a compact package when not in use. A pocket 52 for holding the groin strap when not in use may also be included.

It is to be appreciated that all embodiments are designed so that a firefighter wearing full turn out gear can efficiently apply the harness—even with very low visibility. When either embodiment of the harness is installed on a downed victim they can be pulled or dragged to safety by one or more firefighters.

Additionally, the most preferred embodiments are designed to be rolled up with all the straps and hardware contained inside for easy deployment. This also allows for easy transportation and storage. Generally, a strap is used to wrap around the rolled up harnesses to keep it from unrolling. This strap has a tab for the firefighter to grab and deploy the rescue harness, and is designed to be used with a gloved hand.

To deploy the harness of the present invention, the firefighter will unroll the harness to expose the chest strap, with the victim in a sitting position being held up by the firefighter's knee behind them. The firefighter will then place the chest strap under the arms of the victim and around their chest. Then, the firefighter will secure the connections and tighten the strap. The firefighter can then follow the pull strap back up to the handle to be ready to remove the victim.

The long back embodiment works the same way but it is bigger and it has more straps to connect. The long back embodiment is preferably designed so that it will initially unroll only enough to expose the chest strap. Velcro fasteners 60 may be used on appropriate surfaces (such as the inside and back or bottom of support 31) to achieve that effect. The firefighter places the top of the pouch on top of the air tank of the victim. When the chest strap has been connected and tightened the firefighter can then pull on a release strap 64 in the center of the harness (which is now exposed) at the bottom of the partially unrolled harness to release the rest of the harness. This strap is secured to the fabric of the harness and can be located and pulled with a gloved hand.

The harnesses preferably have one continuous strap on the outside edges of the harness which is the backbone or strength of the harnesses. In the center of this strap is the handle for pulling. The handle is preferably thicker than the strap so it will be easy to find with a gloved hand in a dark environment. This will be the reference point for firefighters when they are securing the harnesses to a downed victim.

The fabric of the long back embodiment may be sewn into a pouch so it can be placed over the air pack of the downed firefighter. Located at the bottom of both harnesses, on the outside of the fabric is a pocket 52 containing the groin strap. It is sewn so that it won't come open during the dragging of the downed victim. All of the straps are sewn to the fabric of the harnesses to keep all straps and hardware in order as one unit.

The harnesses may include a top strap 53 that connects the two side straps 56 together. A lifting loop 37 at the top of the harness (preferably in the center of top strap 53) is also preferably included. A support strap 54 that connects all or some of top strap 53, lifting loop 37, side straps 56, and chest strap 32, helps take the strain off the fabric during lifting.

The preferred trapezoidal design of the harnesses helps support the head and or helmet of the downed victim. When the pull strap is pulled tight by the handle it will lift the victim's head off the ground.

The webbing and fabric used in the harness should be very durable and strong, and may also be fire resistive.

The front of the victim will be exposed when using this rescue harness to allow access to the air pack controls along with the straps and buckles of the air pack harness. The open front of this rescue harness will also allow for quicker deployment.

While the invention has been illustrated and described in detail in the drawings and foregoing description, the same are to be considered as illustrative and not restrictive in character, it being understood that only the preferred embodiments have been shown and described, and that all changes and modifications that come within the spirit of the invention are desired to be protected.

What is claimed:

1. A rescue harness, comprising:
(a) a flexible head/neck support member for supporting a victim's head and neck when the harness is being used to pull the victim to safety;
(b) a chest strap with attachment means at each end of the strap, suitable for holding the victim in the harness by “buckling” the strap around the person's chest; and
(c) a grip attached to upper edge of the head support, the grip being suitable for use by gloved firefighters for pulling a person strapped in the harness from a building;
wherein said harness is open to the front when strapped to a victim's back.

2. A rescue harness according to claim 1, and further comprising a groin strap for further securing the victim in the harness, said groin strap having first and second ends connected to said chest strap, wherein at least one of said ends is releasably connected to said chest strap, and wherein said groin strap is suitable for assisting in securing a rescue victim in the harness by releasably holding the victim's torso and hips in the harness.

3. The rescue harness of claim 1 wherein said chest strap is releasably secured with a buckle.

4. The rescue harness of claim 1 wherein said chest strap is releasably secured with Velcro fasteners.

5. The rescue harness of claim 1 wherein said chest strap is releasably secured by tying the ends of the strap together.

6. The rescue harness of claim 1 wherein said head support is made of a fire-resistant fabric.

7. The rescue harness of claim 1 wherein said head support additionally supports the victim's neck and shoulders.

8. A rescue harness consisting essentially of:
(a) a head support, said head support having an upper portion and a lower portion;
(b) a-chest strap attached to the lower portion of said head support, said chest strap being suitable for securing a rescue victim in the harness by releasably securing the strap around the victim's chest;
(c) a grip attached to the upper portion of said head support, said grip being suitable for pulling the harness with a victim secured therein; and
(d) at least one groin strap for further securing a victim in the harness, said groin strap having first and second ends connected to said chest strap, wherein at least one of said ends is releasably connected to said chest strap, and wherein said groin strap is suitable for assisting in securing a rescue victim in the harness by releasably holding the victim's torso and hips in the harness.
